(19) United States
(12) Patent Application Publication
(10) Pub. No.: US 2021/0357883 A1
(43) Pub. Date: Nov. 18, 2021

(54) PAYMENT METHOD CAPABLE OF AUTOMATICALLY RECOGNIZING PAYMENT AMOUNT

(71) Applicant: Jerry Hans Urban PETTERSSON, Dongguan (CN)

(72) Inventor: Jerry Hans Urban PETTERSSON, Dongguan (CN)

(21) Appl. No.: 17/286,515

(22) PCT Filed: Oct. 22, 2019
(86) PCT No.: PCT/CN2019/112532

§ 371 Date: Apr. 19, 2021

(30) Foreign Application Priority Data
Oct. 22, 2018 (CN) 201811226196.0

(51) Int. Cl. G06Q 20/08; G06Q 20/32; G06Q 20/42

(52) U.S. Cl. CPC G06Q 20/0855; G06Q 20/3278; G06Q 20/42; G06Q 20/3274

(57) ABSTRACT

The present invention provides a payment method capable of automatically recognizing the payment amount, comprising: a camera recognition device connected to a network and communicating with the network; the camera recognition device is provided with at least one camera, and the camera recognition device has a unique ID number and is communicationally connected to a network processing unit and/or a local processing unit. Compared with that prior art, the payment method capable of automatically recognizing the payment amount provided by the present invention enables different types of POS systems to perform data transmission with the network by means of the camera recognition device, so that merchants and consumers do not have to manually enter the values of consumption amounts, thereby reducing operation procedures and steps; photos or videos displayed by the customers in a POS store are recognized by means of OCR technology, NFC or AI technology, and the values of the transaction amounts in the store are recognized using the camera subjected to processing such as image correction, optical character recognition and scene detection AI image recognition, and then the consumers directly make transaction payments.

### FIELD OF THE DISCLOSURE

The present disclosure relates to a field of electronic information, in particular, to a payment method capable of automatically recognizing payment amount.

### BACKGROUND OF THE DISCLOSURE

At present, mobile payment is very convenient in large chain stores such as McDonald's and KFC. Such large chain stores are equipped with unified POS systems or payment systems, which can be easily connected together via the Internet to perform unified management and payment, thereby simplifying the steps for cashiers or consumers to manually enter the transaction amount. However, for small shops with different types of POS payment systems, some are connected to the Internet, and some are not, so that unified management and payment becomes unavailable. Accordingly, for small shops, consumers or cashiers must manually enter the value of the transaction amount and then complete the corresponding payment, and as a result the value of the transaction amount cannot be directly obtained on the POS system for direct payment, making it time-consuming, inconvenient, and not suitable for the fast-paced life today. If unified management is required, different types of POS systems in each store have to be connected to the Internet, which, however, is not practical since it takes much time for installation and debugging and consumes a lot of manpower and material resources. The present disclosure recognizes photos or videos displayed by consumers of a POS store by means of OCR technology, NFC or AI technology, and recognizes values of transaction amounts in the store with cameras subjected to processing such as image correction, optical character recognition and scene detection AI image recognition for direct payment of consumers.

### SUMMARY OF THE DISCLOSURE

The object of the present disclosure is to provide a payment method capable of automatically recognizing payment amount for solution of the problems in the above background art.

In order to achieve the object, the present disclosure provides the following technical solutions:

A payment method capable of automatically recognizing payment amount, including a camera recognition device connected to a network and communicating with the network, the camera recognition device being provided with at least one camera and having a unique ID number for communicational connection with a network processing unit and/or a local processing unit

A first payment method is specifically as follows:

1) Taking photos of a display screen of a cash register device through the camera;

2) Sending the photos taken in the step 1) to the network processing unit and/or the local processing unit;

3) Performing systematical identification on the photos in the step 2) to select areas of the display screen of the cash register device;

4) Text scanning the photos selected in the step 3) to identify text areas;

5) Recognizing a text value in the text areas in the step 4) using the network processing unit and/or local processing unit;

6) Sending the value recognized in the step 5) and the ID number of the camera to a third-party payment processor via the Internet;

7) Identifying a consumer by reading or scanning a payment code in a consumer's mobile phone through the camera, and sending the scanned or read data to the third-party payment processor;

8) Sending a payment request to the consumer's mobile phone by the third-party payment processor and/or obtaining payment authorization from the third-party payment processor; and

9) Sending payment confirmation information to the camera recognition device via the third-party payment processor after completion of the payment;

A second payment method is specifically as follows:

1) Recognizing a consumer by reading or scanning a payment code in the consumer's mobile phone through the camera, and sending the scanned or read data to a third-party payment processor;

2) Taking photos of a display screen of a cash register device through the camera;

3) Sending the photos taken in the step 2) to the network processing unit and/or the local processing unit;

4) Performing systematical identification on the photos in the step 3) to select areas of the display screen of the cash register device;

5) Text scanning the photos selected in the step 4) to identify text areas;

6) Recognizing a text value in the text areas in the step 5) using the network processing unit and/or local processing unit;

7) Sending the value recognized in the step 6) and the ID number of the camera to a third-party payment processor via the Internet;

8) Sending a payment request to the consumer's mobile phone by the third-party payment processor and/or obtaining payment authorization from the third-party payment processor; and

9) Sending payment confirmation information to the camera recognition device via the third-party payment processor after completion of the payment;

A third payment method is specifically as follows:

1) Taking photos of a display screen of a cash register device through the camera;

2) Sending the photos taken in the step 1) to the network processing unit and/or the local processing unit;

3) Recognizing a text value from information of the photos in the step 2) by means of AI Deep Learning of the network processing unit and/or the local processing unit;

4) Sending the value recognized in the step 3) and the ID number of the camera to a third-party payment processor via the Internet;

5) Identifying a consumer by reading or scanning a payment code in the consumer's mobile phone through the camera, and sending the scanned or read data to the third-party payment processor;

6) Sending a payment request to the consumer's mobile phone by the third-party payment processor and/or obtaining payment authorization from the third-party payment processor; and

7) Sending payment confirmation information to the camera recognition device via the third-party payment processor after completion of the payment;

A fourth payment method is specifically as follows:

1) Identifying a consumer by reading or scanning a payment code in the consumer's mobile phone through the camera, and sending the scanned or read data to the third-party payment processor;

2) Taking photos of a display screen of a cash register device through the camera;

3) Sending the photos taken in the step 1) to the network processing unit and/or the local processing unit;

4) Recognizing a text value from information of the photos in the step 3) by means of AI Deep Learning of the network processing unit and/or the local processing unit;

5) Sending the value recognized in the step 4) and the ID number of the camera to a third-party payment processor via the Internet;

6) Sending a payment request to the consumer's mobile phone by the third-party payment processor and/or obtaining payment authorization from the third-party payment processor; and

7) Sending payment confirmation information to the camera recognition device via the third-party payment processor after completion of the payment.

The camera recognition device is provided with two opposing cameras, wherein a first camera is used to take photos of the display screen of the cash register device, and a second camera is used to read or scan the payment code in the consumer's mobile phone.

The second camera reads or scans the payment code in the consumer's mobile phone and sends it to the third-party payment processor, by which the merchant can obtain payer's payment data.

A display is provided on the side of the camera recognition device, in which display merchant's payment code is displayed, and by means of consumer's scanning the merchant's payment code, the obtained payment code is sent to the third-party payment processor, and through the third-party payment processor the consumer obtains the ID information and/or payment amount of the camera recognition device of the merchant.

The unique ID number of the camera recognition device is a shop ID number or a camera ID number.

The camera recognition device is provided with an NFC sensing area for payment transaction.

The camera recognition device is provided with a warning light for indicating whether the payment transaction succeeds or not.

Compared with the prior art, the payment method capable of automatically recognizing the payment amount provided by the present disclosure enables different types of POS systems to perform data transmission with the network by means of the camera recognition device, so that merchants and consumers do not have to manually enter the values of consumption amounts, thereby reducing operation procedures and steps; photos or videos displayed by the customers in a POS store are recognized by means of OCR technology, NFC or AI technology, and the values of the transaction amounts in the store are recognized using the camera subjected to processing such as image correction, optical character recognition and scene detection AI image recognition, and then the consumers directly make transaction payments.

### BRIEF DESCRIPTION OF THE DRAWINGS

FIG. 1 is a schematic diagram of the use of the camera recognition device;

FIG. 2 is a schematic diagram of the structure of the camera recognition device.

### DETAILED DESCRIPTION OF THE EMBODIMENT(S) OF THE DISCLOSURE

The technical solutions in the embodiments of the present disclosure will be clearly and completely described below with reference to the accompanying drawings in the embodiments of the present disclosure.

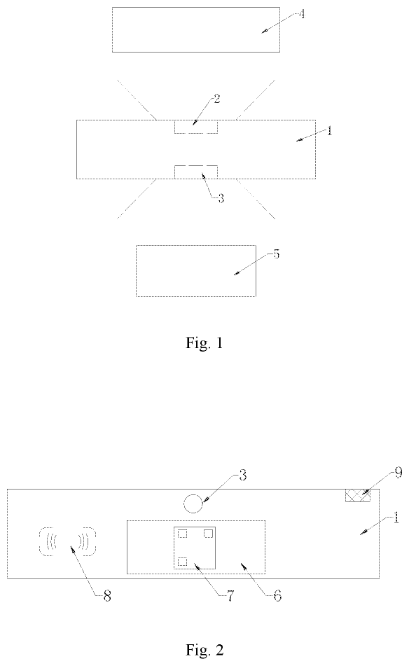

Specific embodiment 1: Referring to FIGS. 1 and 2, in an embodiment of the present disclosure, a payment method capable of automatically recognizing the payment amount includes a camera recognition device 1 connected to a network and communicating with the network. The camera recognition device 1 is provided with two cameras, wherein a first camera 2 is used to take photos of a display screen 4 of a cash register device and a second camera 3 is used to read or scan a payment code in a consumer's mobile phone 3;

A display 3 is provided on the side of the camera recognition device 1, in which display 6 a merchant's payment code 7 is displayed. The consumer can scan the merchant's payment code 7 to send the acquired payment code information to a third-party payment processor. The consumer obtains ID information and/or payment amount of the merchant's camera recognition device 1 through the third-party payment processor. The second camera 3 reads or scans the payment code in the consumer's mobile phone 3 and sends it to the third-party payment processor, and the merchant can obtain payer's payment data through the third-party payment processor.

The camera recognition device 1 has a unique ID number to communicate with a network processing unit and/or a local processing unit; the unique ID number of the camera recognition device 1 is a shop ID number or a camera ID number, and the camera recognition device 1 is provided with an NFC sensing area 8 for payment transaction; the camera recognition device 1 is provided with a warning light 9 for indicating whether the payment transaction succeeds or not; if the transaction succeeds, the warning light 9 will light up to remind the consumer and the merchant of a successful transaction, and the consumer no longer needs to show success interface of mobile payment transaction to the merchant.

A first payment method is specifically as follows:

1) Taking photos of a display screen 4 of a cash register device through the first camera 1;

2) Sending the photos taken in the step 1) to the network processing unit and/or the local processing unit;

3) Performing systematical identification on the photos in the step 2) to select areas of the display screen 4 of the cash register device;

4) Text scanning the photos selected in the step 3) to identify text areas;

5) Recognizing a text value of the amount in the display screen 4 of the cash register device in the text areas in the step 4) using the network processing unit and/or local processing unit;

6) Sending the value recognized in the step 5) and the ID number of the camera to a third-party payment processor via the Internet for data statistics;

7) Identifying a consumer by reading or scanning a payment code in a consumer's mobile phone 5 through the second camera 3, and sending the scanned or read data to the third-party payment processor;

8) Sending a payment request to the consumer's mobile phone 5 by the third-party payment processor and/or obtaining payment authorization from the third-party payment processor; or putting the consumer's mobile phone close to the NFC sensing area 8 to obtain relevant data to make payment; and

9) Sending payment confirmation information to the camera recognition device 1 via the third-party payment processor after completion of the payment, lighting up the warning light 9 to indicate a successful transaction.

Specific embodiment 2: differences between a second payment method and the first payment method are specifically as follows:

1) Recognizing a consumer by reading or scanning a payment code in the consumer's mobile phone 5 through the second camera 3, and sending the scanned or read data to a third-party payment processor;

2) Taking photos of a display screen 4 of a cash register device through the first camera 2;

3) Sending the photos taken in the step 2) to the network processing unit and/or the local processing unit;

4) Performing systematical identification on the photos in the step 3) to select areas of the display screen 4 of the cash register device;

5) Text scanning the photos selected in the step 4) to identify text areas;

6) Recognizing a text value in the text areas in the step 5) using the network processing unit and/or local processing unit;

7) Sending the value recognized in the step 6) and the ID number of the camera to a third-party payment processor via the Internet;

8) Sending a payment request to the consumer's mobile phone 5 by the third-party payment processor and/or obtaining payment authorization from the third-party payment processor; and

9) Sending payment confirmation information to the camera recognition device 1 via the third-party payment processor after completion of the payment, lighting up the warning light 9 to indicate a successful transaction.

Specific embodiment 3: a third payment method is specifically as follows:

Referring to FIGS. 1 and 2, in an embodiment of the present disclosure, a payment method capable of automatically recognizing the payment amount includes a camera recognition device 1 connected to a network and communicating with the network. The camera recognition device 1 is provided with two cameras, wherein a first camera 2 is used to take photos of a display screen 4 of a cash register device and a second camera 3 is used to read or scan a payment code in a consumer's mobile phone 5;

A display 6 is provided on the side of the camera recognition device 1, in which display a merchant's payment code 7 is displayed. The consumer can scan the merchant's payment code 7 to send the acquired payment code information to a third-party payment processor. The consumer obtains ID information and/or payment amount of the merchant's camera recognition device 1 through the third-party payment processor. The second camera 3 reads or scans the payment code in the consumer's mobile phone 5 and sends it to the third-party payment processor, and the merchant can obtain payer's payment data through the third-party payment processor.

The camera recognition device 1 has a unique ID number to communicate with a network processing unit and/or a local processing unit; the network processing unit and/or the local processing unit is provided with AI Deep Learning program, by which data processing computing could be performed automatically.

The unique ID number of the camera recognition device 1 is a shop ID number or a camera ID number, and the camera recognition device 1 is provided with an NFC sensing area 8 for payment transaction; the camera recognition device 1 is provided with a warning light 9 for indicating whether the payment transaction succeeds or not; if the transaction succeeds, the warning light 9 will light up to remind the consumer and the merchant of a successful transaction, and the consumer no longer needs to show success interface of mobile payment transaction to the merchant.

1) Taking photos of a display screen 4 of a cash register device through the first camera 2;

2) Sending the photos taken in the step 1) to the network processing unit and/or the local processing unit;

3) Recognizing a text value from information of the photos in the step 2) by means of AI Deep Learning of the network processing unit and/or the local processing unit;

4) Sending the value recognized in the step 3) and the ID number of the camera to a third-party payment processor via the Internet;

5) Identifying a consumer by reading or scanning a payment code in the consumer's mobile phone 5 through the second camera 3, and sending the scanned or read data to the third-party payment processor;

6) Sending a payment request to the consumer's mobile phone 5 by the third-party payment processor and/or obtaining payment authorization from the third-party payment processor; and

7) Sending payment confirmation information to the camera recognition device 1 via the third-party payment processor after completion of the payment, lighting up the warning light 9 to indicate a successful transaction.

Specific embodiment 4: differences between a fourth payment method and the third payment method are specifically as follows:

1) Identifying a consumer by reading or scanning a payment code in the consumer's mobile phone 5 through the second camera 3, and sending the scanned or read data to the third-party payment processor;

2) Taking photos of a display screen 4 of a cash register device through the first camera 2;

3) Sending the photos taken in the step 1) to the network processing unit and/or the local processing unit;

4) Recognizing a text value from information of the photos in the step 3) by means of AI Deep Learning of the network processing unit and/or the local processing unit;

5) Sending the value recognized in the step 4) and the ID number of the camera to a third-party payment processor via the Internet;

6) Sending a payment request to the consumer's mobile phone 5 by the third-party payment processor and/or obtaining payment authorization from the third-party payment processor; and

7) Sending payment confirmation information to the camera recognition device 1 via the third-party payment processor after completion of the payment, lighting up the warning light 9 to indicate a successful transaction.

Compared with the prior art, the payment method capable of automatically recognizing the payment amount provided by the present disclosure enables different types of POS systems to perform data transmission with the network by means of the camera recognition device, so that merchants and consumers do not have to manually enter the values of consumption amounts, thereby reducing operation procedures and steps; photos or videos displayed by the customers in a POS store are recognized by means of OCR technology, NFC or AI technology, and the values of the transaction amounts in the store are recognized using the camera subjected to processing such as image correction, optical character recognition and scene detection AI image recognition, and then the consumers directly make transaction payments.

For those skilled in the art, it is obvious that the present disclosure is not limited to the details of the foregoing exemplary embodiments, and the present disclosure can be implemented in other specific forms without departing from the spirit or basic characteristics of the present disclosure. Therefore, no matter from which point of view, the embodiments should be regarded as exemplary and non-limiting. The scope of the present disclosure should be defined by the appended claims rather than the foregoing description, and therefore all of changes within the meaning and scope equivalent to the technical features of the claims shall be included in the present disclosure. Any reference signs in the claims should not be regarded as limiting the claims involved.

In addition, it should be appreciated that this specification is described in accordance with the embodiments, but not every embodiment only includes one independent technical solution. This drafting of the specification is only for making it easy to understand. Persons skilled in the art should regard the specification as a whole, and the technical solutions in the various embodiments can also be appropriately combined to form other embodiments that can be understood by those skilled in the art.

What is claimed is:

1. A payment method capable of automatically recognizing payment amount, characterized in comprising a camera recognition device connected to a network and communicating with the network, the camera recognition device being provided with at least one camera and having a unique ID number for communicational connection with a network processing unit and/or a local processing unit;
a first payment method is specifically as follows:
1) taking photos of a display screen of a cash register device through the camera;
2) sending the photos taken in the step 1) to the network processing unit and/or the local processing unit;
3) performing systematical identification on the photos in the step 2) to select areas of the display screen of the cash register device;
4) text scanning the photos selected in the step 3) to identify text areas;
5) recognizing a text value in the text areas in the step 4) using the network processing unit and/or local processing unit;
6) sending the value recognized in the step 5) and the ID number of the camera to a third-party payment processor via the Internet;
7) identifying a consumer by reading or scanning a payment code in a consumer's mobile phone through the camera, and sending the scanned or read data to the third-party payment processor;
8) sending a payment request to the consumer's mobile phone by the third-party payment processor and/or obtaining payment authorization from the third-party payment processor; and
9) sending payment confirmation information to the camera recognition device via the third-party payment processor after completion of the payment;
a second payment method is specifically as follows:
1) recognizing a consumer by reading or scanning a payment code in a consumer's mobile phone through the camera, and sending the scanned or read data to a third-party payment processor;
2) taking photos of a display screen of a cash register device through the camera;
3) sending the photos taken in the step 2) to the network processing unit and/or the local processing unit;
4) performing systematical identification on the photos in the step 3) to select areas of the display screen of the cash register device;
5) text scanning the photos selected in the step 4) to identify text areas;
6) recognizing a text value in the text areas in the step 5) using the network processing unit and/or local processing unit;
7) sending the value recognized in the step 6) and the ID number of the camera to a third-party payment processor via the Internet;
8) sending a payment request to the consumer's mobile phone by the third-party payment processor and/or obtaining payment authorization from the third-party payment processor; and
9) sending payment confirmation information to the camera recognition device via the third-party payment processor after completion of the payment;
a third payment method is specifically as follows:
1) taking photos of a display screen of a cash register device through the camera;
2) sending the photos taken in the step 1) to the network processing unit and/or the local processing unit;
3) recognizing a text value from information of the photos in the step 2) by means of a deep learning of the network processing unit and/or the local processing unit;
4) sending the value recognized in the step 3) and the ID number of the camera to a third-party payment processor via the Internet;
5) identifying a consumer by reading or scanning a payment code in the consumer's mobile phone through the camera, and sending the scanned or read data to the third-party payment processor;
6) sending a payment request to the consumer's mobile phone by the third-party payment processor and/or obtaining payment authorization from the third-party payment processor; and
7) sending payment confirmation information to the camera recognition device via the third-party payment processor after completion of the payment;
a fourth payment method is specifically as follows:
1) identifying a consumer by reading or scanning a payment code in the consumer's mobile phone through the camera, and sending the scanned or read data to the third-party payment processor;
2) taking photos of a display screen of a cash register device through the camera;
3) sending the photos taken in the step 1) to the network processing unit and/or the local processing unit;
4) recognizing a text value from information of the photos in the step 3) by means of a deep learning of the network processing unit and/or the local processing unit;
5) sending the value recognized in the step 4) and the ID number of the camera to a third-party payment processor via the Internet;
6) sending a payment request to the consumer's mobile phone by the third-party payment processor and/or obtaining payment authorization from the third-party payment processor; and
7) sending payment confirmation information to the camera recognition device via the third-party payment processor after completion of the payment.

2. The payment method capable of automatically recognizing payment amount according to claim 1, wherein the camera recognition device is provided with two opposing cameras, wherein a first camera is used to take the photos of the display screen of the cash register device, and a second camera is used to read or scan the payment code in the consumer's mobile phone.

3. The payment method capable of automatically recognizing payment amount according to claim 2, wherein the second camera reads or scans the payment code in the consumer's mobile phone and sends it to the third-party payment processor, by which a merchant can obtain payer's payment data.

4. The payment method capable of automatically recognizing payment amount according to claim 1, wherein a display is provided with on the side of the camera recognition device, in which display merchant's payment code is displayed, and by means of consumer's scanning the merchant's payment code, the obtained payment code is sent to the third-party payment processor, and through the third-party payment processor the consumer obtains the ID information and/or payment amount of the camera recognition device of the merchant.

5. The payment method capable of automatically recognizing payment amount according to claim 1, wherein the unique ID number of the camera recognition device is a shop ID number or a camera ID number.

6. The payment method capable of automatically recognizing payment amount according to claim 1, wherein the camera recognition device is provided with an NFC sensing area for payment transaction.

7. The payment method capable of automatically recognizing payment amount according to claim 1, wherein the camera recognition device is provided with a warning light for indicating whether the payment transaction succeeds or not.
